(19) United States
(12) Patent Application Publication
(10) Pub. No.: US 2023/0017468 A1
(43) Pub. Date: Jan. 19, 2023

(54) MACHINE LEARNING BASED SERVER FOR PRIVACY PROTECTION LEVEL ADJUSTMENT

(71) Applicant: International Business Machines Corporation, Armonk, NY (US)

(72) Inventors: Randy A. Rendahl, Raleigh, NC (US); Su Liu, Austin, TX (US); Jeremy R. Fox, Georgetown, TX (US); Hamid Majdabadi, Ottawa (CA)

(21) Appl. No.: 17/378,880

(22) Filed: Jul. 19, 2021

(51) Int. Cl. G06Q 20/40; H04L 29/08; G06N 20/00; G06K 9/00

(52) U.S. Cl. CPC G06Q 20/4016; G06Q 20/405; G06Q 20/407; H04L 67/26; G06N 20/00; G06K 9/00335

(57) ABSTRACT

A computer-implemented method, a computer program product, and a computer system for preventing scams in commerce transactions. The computer system identifies a critical decision-making process of a user in a commerce transaction that involves exposing personal data. The computer system receives current stress factors of the user. The computer system calculates a current stress score of the user, based on the current stress factors, by using a machine learning model that correlates behavioral patterns of the user and stress levels of the user. The computer system determines an abnormal level of the current stress score, based on predetermined thresholds for different abnormal scores. The computer system determines a privacy protection level in the critical decision-making process, based on the abnormal level. The computer system takes an action for preventing scams in the commerce transaction, based on the privacy protection level.

### BACKGROUND

The present invention relates generally to privacy protection using a machine learning based server, and more particularly to a machine learning based server for privacy protection level adjustment (PPLA) for preventing scams in commerce transactions.

In commerce transactions, scammers deceive or defraud others and obtain person's personal data of others, and scammers use the person's personal data of others, without authorization, to deceive or defraud someone else. In most cases of scams, vulnerable individuals are targeted by scammers. For example, stressful situations make individuals vulnerable. Individuals sometimes need to make important decisions, when the stakes are high and when not enough information or cognitive resources are available to guarantee a sound choice. However, stressful situations may dramatically change decision-making strategies, leading to different decisions from what would be made without such stressful situations.

### SUMMARY

In one aspect, a computer-implemented method for preventing scams in commerce transactions is provided. The computer-implemented method includes identifying a critical decision-making process of a user in a commerce transaction that involves exposing personal data. The computer-implemented method further includes receiving current stress factors of the user. The computer-implemented method further includes calculating a current stress score of the user, based on the current stress factors, by using a machine learning model that correlates behavioral patterns of the user and stress levels of the user. The computer-implemented method further includes determining an abnormal level of the current stress score, based on predetermined thresholds for different abnormal scores. The computer-implemented method further includes determining a privacy protection level in the critical decision-making process, based on the abnormal level. The computer-implemented method further includes taking an action for preventing scams in the commerce transaction, based on the privacy protection level.

In another aspect, a computer program product for preventing scams in commerce transactions is provided. The computer program product comprises a computer readable storage medium having program instructions embodied therewith, and the program instructions are executable by one or more processors. The program instructions are executable to: identify a critical decision-making process of a user in a commerce transaction that involves exposing personal data; receive current stress factors of the user; calculate a current stress score of the user, based on the current stress factors, by using a machine learning model that correlates behavioral patterns of the user and stress levels of the user; determine an abnormal level of the current stress score, based on predetermined thresholds for different abnormal scores; determine a privacy protection level in the critical decision-making process, based on the abnormal level; and take an action for preventing scams in the commerce transaction, based on the privacy protection level.

In yet another aspect, a computer system for preventing scams in commerce transactions is provided. The computer system comprises one or more processors, one or more computer readable tangible storage devices, and program instructions stored on at least one of the one or more computer readable tangible storage devices for execution by at least one of the one or more processors. The program instructions are executable to identify a critical decision-making process of a user in a commerce transaction that involves exposing personal data. The program instructions are further executable to receive current stress factors of the user. The program instructions are further executable to calculate a current stress score of the user, based on the current stress factors, by using a machine learning model that correlates behavioral patterns of the user and stress levels of the user. The program instructions are further executable to determine an abnormal level of the current stress score, based on predetermined thresholds for different abnormal scores. The program instructions are further executable to determine a privacy protection level in the critical decision-making process, based on the abnormal level. The program instructions are further executable to take an action for preventing scams in the commerce transaction, based on the privacy protection level.

### BRIEF DESCRIPTION OF THE SEVERAL VIEWS OF THE DRAWINGS

FIG. 1 is a systematic diagram illustrating a system of privacy protection level adjustment (PPLA), in accordance with one embodiment of the present invention.

FIG. 2 presents a flowchart showing operational steps of preventing scams in commerce transactions, in accordance with one embodiment of the present invention.

FIG. 3 is a diagram illustrating components of a computing device, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiments of the present invention disclose a system of privacy protection level adjustment (PPLA) for preventing scams in commerce transactions. The PPLA system takes proper predefined privacy protect actions according to calculated stress scores in real time. The PPLA system correlates existing health data and stress scores with a user profile and analytics of a behavioral pattern of a user, when a user interacts with devices and digital communications. The PPLA system presents a predictive alert leading to an informed decision-making opportunity. Embodiments of the present invention introduce user-defined preferences and thresholds. The PPLA system is customizable based on the user-defined preferences and thresholds. When a user make a decision that leads to exposing personal data, current stress anomaly data of a user will trigger the PPLA system to take a range of actions; for example, the PPLA system may alert a user with a probability score of possible fraudulency, the PPLA system may temporarily block access to a user data folder or relevant applications, the PPLA system may intercept outgoing electronic communications and place them in a holding pen pending resolution, and/or the PPLA system may send an alert notification to a designated trustee to receive a call for a consultation and sharing the scenario.

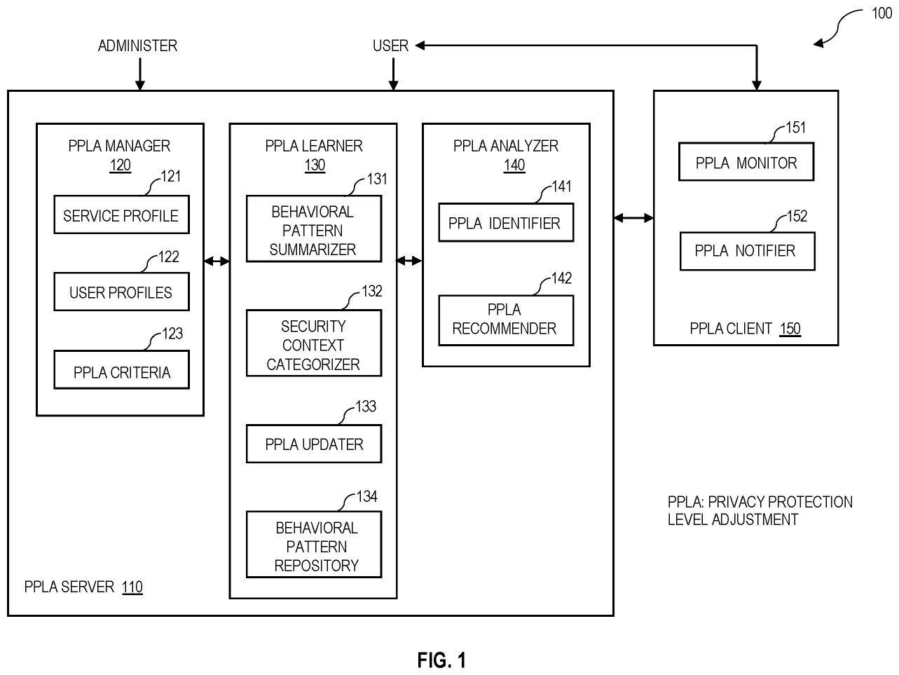

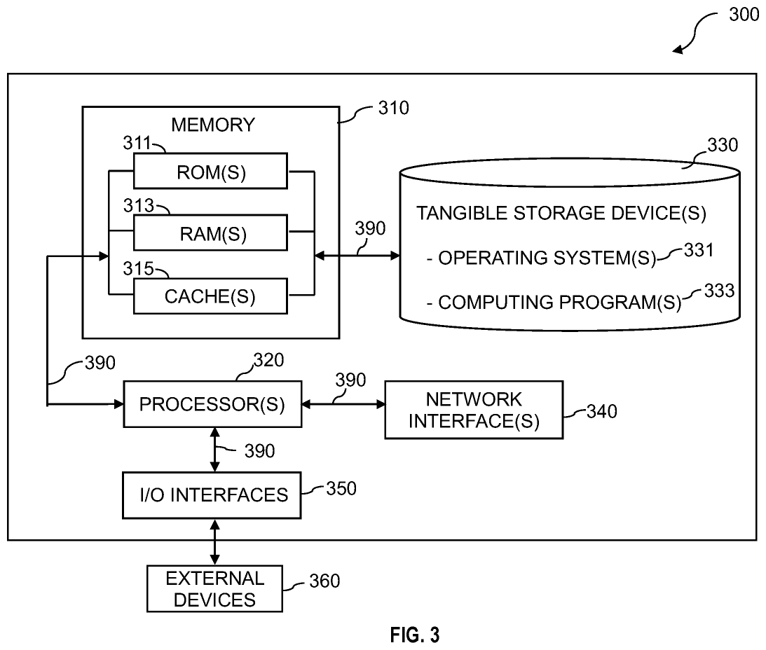

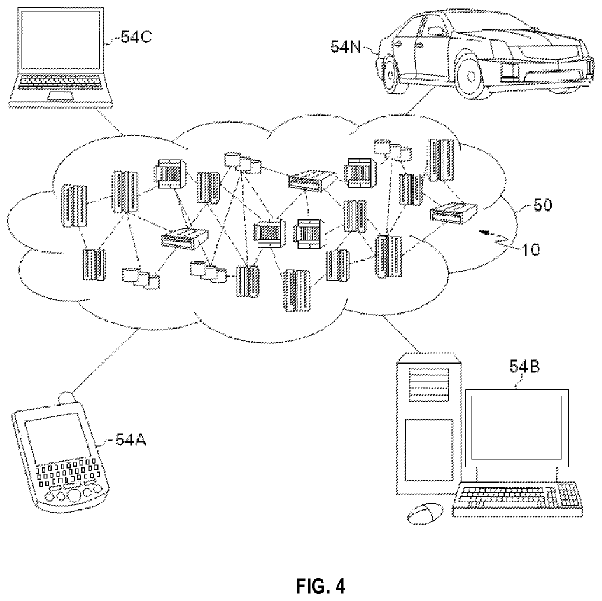

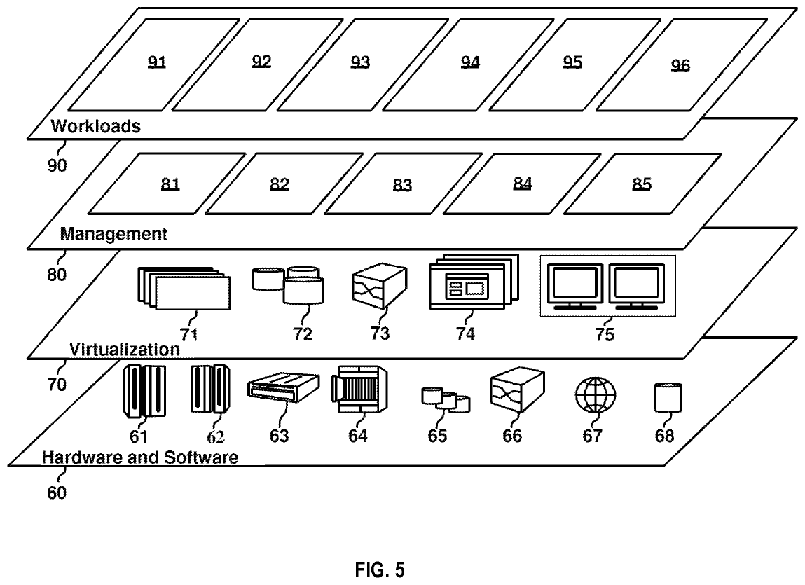

FIG. 1 is a systematic diagram illustrating system 100 of privacy protection level adjustment (PPLA system 100), in accordance with one embodiment of the present invention. PPLA system 100 may be implemented on one or more computing devices or servers. A computing device or server is described in more detail in later paragraphs with reference to FIG. 3. PPLA system 100 may be implemented in a cloud computing environment. The cloud computing environment is described in more detail in later paragraphs with reference to FIG. 4 and FIG. 5.

PPLA system 100 comprises PPLA server 110 and PPLA client 150. PPLA server 110 is a server application for receiving client requests from PPLA client 150 and providing PPLA service. PPLA server 110 comprises PPLA manager 120, PPLA learner 130, and PPLA analyzer 140. PPLA client 150 includes PPLA monitor 151 and PPLA notifier 152. A user has an option to opt in or opt out the service provided by PPLA system 100. The consent of the user is required in using the service provided by PPLA system 100. In acquiring, processing, storing, transferring, and using the data by PPLA system 100, laws are observed and privacy of the user is protected.

PPLA manager 120 is a user interface for configuring and managing PPLA service, including profile management, action management, and comparison and predictive modules. PPLA manager 120 comprises service profile 121. Service profile 121 is configuration file for saving the configured PPLA settings, including, for example, enabling or disabling the PPLA service, or partially enabling/disabling features. PPLA manager 120 further comprises user profile 122. User profile 122 defines a set of user preferences related to risk management and preventative actions, including, for example, timestamps, age, location, behavioral patterns, actions, alert types, third party notification, device access settings, stress thresholds, and other related preferences. PPLA manager 120 further comprises PPLA criteria 123. PPLA criteria 123 is a set of rules for determining the security contexts for managing secure device communications, to secure Internet of things (IoT) devices used by the user and enable PPLA server 110 to access the IoT devices.

PPLA learner 130 is a module for analyzing a relationship between stress levels and individual's behavior. PPLA learner 130 includes at least following modules in order to support machine learning features of PPLA system 100. PPLA learner 130 includes behavioral pattern summarizer 131. Behavioral pattern summarizer 131 is a module for learning a set of new behavioral patterns under certain stress. Machine learning is used to understand and predict an individual's behavior at a granular level for each interaction; for example, machine learning can predict interactions or actions based on the following: the type of the new medication, the user may get agitated, or the blood pressure of the user may temporarily fluctuate. The summarized behavioral patterns is updated to user profile 122 of the user. PPLA learner 130 further includes security context categorizer 132. Security context categorizer 132 is a set of predefined or learned security contexts and a smart context categorizer to prevent any false positive. For example, security context categorizer 132 includes expected anomaly, such as at the gym, after taking medication, or any other criteria that may temporarily impact the stress level. PPLA learner 130 further includes PPLA updater 133. PPLA updater 133 is a learner module to record and update stress levels during new activities preventing false positive. PPLA learner 130 further includes behavioral pattern repository 134. Behavioral pattern repository 134 is a database for saving summarized behavioral patterns under a certain stress level.

PPLA analyzer 140 is a module for analyzing a decision-making process through tracking user's activities and monitoring user's behavioral and mental states through sensors in surrounding IoT device(s) or personal assistant device(s). For example, tracking user's activities include tracking connected devices, recent postings, and meetings and appointments. PPLA analyzer 140 comprises PPLA identifier 141. PPLA identifier 141 is a module for identifying a user's state as critical in a decision-making process in a commerce transaction. PPLA analyzer 140 further comprises PPLA recommender 142. PPLA recommender 142 is a module for managing probability threshold predictive measure to determine on notifying and augmenting the critical decision-making process through inputting analysis of a machine learning trained model.

PPLA monitor 151 on PPLA client 150 is a module for monitoring and collecting stress factors under certain behaviors. The stress factors under certain behaviors are received from users' device(s) and IoT sensor(s) from proximity or connected devices, and they are any measures (such as blood pressure change) that contribute to stress level change. PPLA monitor 151 is also a module for monitoring transaction events and related network security contexts between devices. PPLA notifier 152 on PPLA client 150 is a module for notifying the user with a reaction recommendation, a current stress level, and risk warning.

In some embodiments, the local processing location of the user is relevant. The user's location is also considered within the analysis as another data point for the equation. This will allow PPLA system 100 to know whether the user is processing a transaction(s) outside of user's normal processing pattern.

In some other embodiments, the context of the user's frame of reference is important as well. Normally, there are patterns within the processing logic of the workflow management. The present invention can identify patterns within the workflow management of data processing. These patterns can help PPLA system 100 to identify a vital indicator when stress is detected because of an abrupt pattern shift or anomaly.

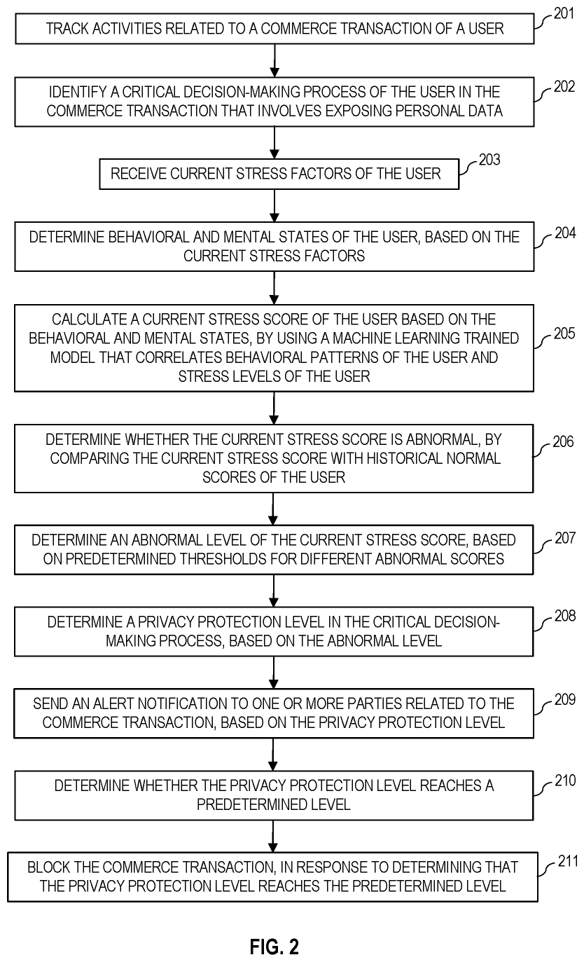

FIG. 2 presents a flowchart showing operational steps of preventing scams in commerce transactions, in accordance with one embodiment of the present invention. The operational steps are implemented by a system of privacy protection level adjustment (PPLA) for preventing scams in commerce transactions (such as PPLA system 100 shown in FIG. 1). The system of PPLA is implemented on one or more computers.

A user has an option to opt in or opt out the service provided by the system of PPLA for preventing scams in commerce transactions. The consent of the user is required in using the service provided by the system of PPLA. In acquiring, processing, storing, transferring, and using the data by the system of PPLA, laws are observed and privacy of the user is protected.

At step 201, the one or more computers track activities related to a commerce transaction of a user. The commerce transaction may be, for example, initiating an electronic funds transfer (EFT) to pay a vendor invoice. The activities may be, for example, user's activities include using connected devices, recent postings, and meetings and appointments. Tracking the activities may be through sensors in surrounding IoT device(s) or personal assistant device(s).

At step 202, the one or more computers identify a critical decision-making process of the user in the commerce transaction that involves exposing personal data. By tracking (at step 201) the user's activities related to the commerce transaction, the one or more computers identify the critical decision-making process. Since the user may disclose personal data (which may be sensitive personal data) to an unknown or unauthenticated party in the decision-making process, the one or more computers identify the decision-making process as critical.

At step 203, the one or more computers receive current stress factors of the user. In detecting the current stress factors of the user, the one or more computers receive the current stress factors from users' device(s) and/or IoT sensor(s) from proximity or connected devices. The current stress factors may be any measures (such as blood pressure change) that contribute to stress level change. In the embodiment shown in FIG. 1, detecting the current stress factors is implemented by PPLA monitor 151 on PPLA client 150, PPLA analyzer 140 on PPLA server 110 receives the current stress factors from PPLA monitor 151

At step 204, the one or more computers determine behavioral and mental states of the user, based on the current stress factors detected at step 203. The one or more computers determine whether the behavioral and mental states of the user are critical to make decisions that may lead to exposing personal data. If the states are critical, the one or more computers identify and tag the behavioral and mental states. At step 205, the one or more computers calculate a current stress score of the user, based on the current stress factors detected at step 203. For determining the current stress score, a machine learning trained model is used, and the machine learning trained model correlates behavioral patterns of the user and stress levels of the user. The machine learning trained model is obtained from learned and past decision-making events in commerce transactions. In the embodiment shown in FIG. 1, steps 204 and 205 are implemented by PPLA analyzer 140 on PPLA server 110; the machine learning trained model is PPLA learner 130 on PPLA server 110.

At step 206, the one or more computers determine whether the current stress score is abnormal, by comparing the current stress score (determined at step 205) with historical normal scores of the user. If the current stress score does not match the historical normal scores and if the difference between the current stress score and the historical normal scores exceeds a user predefined threshold, then the current stress score is abnormal. In the embodiment shown in FIG. 1, step 206 is implemented by PPLA analyzer 140 on PPLA server 110. In the embodiment shown in FIG. 1, the historical normal scores of the user are stored in user profiles 122 on PPLA server 110, and the user predefined threshold is included in user profiles 122 on PPLA server 110.

At step 207, the one or more computers determine an abnormal level of the current stress score, based on predetermined thresholds of different abnormal scores. For a certain value of the current stress score, the one or more computers assigns an abnormal level. In the embodiment shown in FIG. 1, step 207 is implemented PPLA analyzer 140 on PPLA server 110. The predetermined thresholds of different abnormal scores may be defined by the user; in the embodiment shown in FIG. 1, the predetermined thresholds of different abnormal levels included in user profiles 122 on PPLA server 110.

At step 208, the one or more computers determine a privacy protection level in the critical decision-making process, based on the abnormal level determined at step 207. Different privacy protection levels may correspond different abnormal scores, and different privacy protection levels may trig different actions taken by the system of PPLA. Based on different privacy protection levels, the one or more computers take different actions, accordingly. In the embodiment shown in FIG. 1, step 208 is implemented PPLA analyzer 140 on PPLA server 110.

One or more actions for preventing scams in the commerce transaction are taken by the system of PPLA are implemented through steps 209-211. At step 209, the one or more computers send an alert notification to one or more parties related to the commercial transaction, based on the privacy protection level. At step 210, the one or more computers determine whether the privacy protection level reaches a predetermined level. In response to determining that the privacy protection level reaches the predetermined level, at step 211, the one or more computers block the commerce transaction. In the embodiment shown in FIG. 1, steps 209-211 are implemented by PPLA server 110; the user receives the notification through PPLA notifier 152 on PPLA client 150.

The user is capable of predefining thresholds for what action or actions will be taken by the system of PPLA. For example, if the stress score is above the normal score(s) by 10%, then the system of PPLA only notifies user; if the stress score is above the normal score(s) by 30%, then the system of PPLA notifies not only the user but also a trustee. A third-party trustee may be designated in user profiles 122 on PPLA server 110. The system of PPLA may simply ask for approval of the commerce transaction that is triggered by the system as suspicious. The system of PPLA may send an alert to a designated trustee to receive a call to consult and share the scenario. For example, if the stress score is above the normal score(s) by 50%, additional to notifying the user and the trustee, the system of PPLA blocks the commerce transaction, puts the commerce transaction in a holding pen until a clearing action is provided, or locks access to user's personal data until the trustee intervenes and unlocks the access.

FIG. 3 is a diagram illustrating components of computing device or server 300, in accordance with one embodiment of the present invention. It should be appreciated that FIG. 3 provides only an illustration of one implementation and does not imply any limitations with regard to the environment in which different embodiments may be implemented.

Referring to FIG. 3, computing device or server 300 includes processor(s) 320, memory 310, and tangible storage device(s) 330. In FIG. 3, communications among the above-mentioned components of computing device or server 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computing device or server 300 further includes I/O interface(s) 350. I/O interface(s) 350 allows for input and output of data with external device(s) 360 that may be connected to computing device or server 300. Computing device or server 300 further includes network interface(s) 340 for communications between computing device or server 300 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of a machine learning based server for privacy protection level adjustment (PPLA) for preventing scams in commerce transactions.

What is claimed is:

1. A computer-implemented method for preventing scams in commerce transactions, the method comprising:
identifying a critical decision-making process of a user in a commerce transaction that involves exposing personal data;
receiving current stress factors of the user;
calculating a current stress score of the user, based on the current stress factors, by using a machine learning model that correlates behavioral patterns of the user and stress levels of the user;
determining an abnormal level of the current stress score, based on predetermined thresholds for different abnormal scores;
determining a privacy protection level in the critical decision-making process, based on the abnormal level; and
taking an action for preventing scams in the commerce transaction, based on the privacy protection level.

2. The computer-implemented method of claim 1, further comprising:
sending an alert notification to the user, based on the privacy protection level.

3. The computer-implemented method of claim 1, further comprising:
sending an alert notification to a trustee designated by the user, based on the privacy protection level.

4. The computer-implemented method of claim 1, further comprising:
blocking the commerce transaction, in response to determining that the privacy protection level reaches a predetermined level.

5. The computer-implemented method of claim 1, wherein identifying the critical decision-making process is by tracking user activities related to the commerce transaction.

6. The computer-implemented method of claim 1, further comprising:
determining behavioral and mental states of the user, based on the current stress factors; and
in response to determining that the behavioral and mental states are critical to make decisions, identifying and tagging the behavioral and mental states.

7. The computer-implemented method of claim 1, further comprising:
comparing the current stress score with historical normal scores of the user; and
determining whether the current stress score is abnormal, based on comparison between the current stress score and the historical normal scores.

8. A computer program product for preventing scams in commerce transactions, the computer program product comprising a computer readable storage medium having program instructions embodied therewith, the program instructions executable by one or more processors, the program instructions executable to:
identify a critical decision-making process of a user in a commerce transaction that involves exposing personal data;
receive current stress factors of the user;
calculate a current stress score of the user, based on the current stress factors, by using a machine learning model that correlates behavioral patterns of the user and stress levels of the user;
determine an abnormal level of the current stress score, based on predetermined thresholds for different abnormal scores;
determine a privacy protection level in the critical decision-making process, based on the abnormal level; and
take an action for preventing scams in the commerce transaction, based on the privacy protection level.

9. The computer program product of claim 8, further comprising the program instructions executable to:
send an alert notification to the user, based on the privacy protection level.

10. The computer program product of claim 8, further comprising the program instructions executable to:
send an alert notification to a trustee designated by the user, based on the privacy protection level.

11. The computer program product of claim 8, further comprising the program instructions executable to:
block the commerce transaction, in response to determining that the privacy protection level reaches a predetermined level.

12. The computer program product of claim 8, wherein identifying the critical decision-making process is by tracking user activities related to the commerce transaction.

13. The computer program product of claim 8, further comprising program instructions executable to:
determine behavioral and mental states of the user, based on the current stress factors; and
in response to determining that the behavioral and mental states are critical to make decisions, identify and tag the behavioral and mental states.

14. The computer program product of claim 8, further comprising the program instructions executable to:
compare the current stress score with historical normal scores of the user; and
determine whether the current stress score is abnormal, based on comparison between the current stress score and the historical normal scores.

15. A computer system for preventing scams in commerce transactions, the computer system comprising:
one or more processors, one or more computer readable tangible storage devices, and program instructions stored on at least one of the one or more computer readable tangible storage devices for execution by at least one of the one or more processors, the program instructions executable to:
identify a critical decision-making process of a user in a commerce transaction that involves exposing personal data;
receive current stress factors of the user;
calculate a current stress score of the user, based on the current stress factors, by using a machine learning model that correlates behavioral patterns of the user and stress levels of the user;
determine an abnormal level of the current stress score, based on predetermined thresholds for different abnormal scores;
determine a privacy protection level in the critical decision-making process, based on the abnormal level; and
take an action for preventing scams in the commerce transaction, based on the privacy protection level.

16. The computer system of claim 15, further comprising the program instructions executable to:
send an alert notification to the user, based on the privacy protection level.

17. The computer system of claim 15, further comprising the program instructions executable to:
send an alert notification to a trustee designated by the user, based on the privacy protection level.

18. The computer system of claim 15, further comprising the program instructions executable to:
block the commerce transaction, in response to determining that the privacy protection level reaches a predetermined level.

19. The computer system of claim 15, further comprising the program instructions executable to:
determine behavioral and mental states of the user, based on the current stress factors; and
in response to determining that the behavioral and mental states are critical to make decisions, identify and tag the behavioral and mental states.

20. The computer system of claim 15, further comprising program instructions executable to:
compare the current stress score with historical normal scores of the user; and
determine whether the current stress score is abnormal, based on comparison between the current stress score and the historical normal scores.
